(19) United States
(12) Patent Application Publication
(10) Pub. No.: US 2010/0211685 A1
(43) Pub. Date: Aug. 19, 2010

(54) PAIRING EXCHANGE

(75) Inventors: Ian McDowall, Cambridge (GB); Timothy Howes, Cambridge (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/682,332

(22) PCT Filed: Sep. 9, 2008
(86) PCT No.: PCT/GB08/03026

§ 371 Date: Apr. 9, 2010

(30) Foreign Application Priority Data
Oct. 9, 2007 (GB) 0719714.8

(51) Int. Cl. G06F 15/16

(52) U.S. Cl. 709/227

(57) ABSTRACT

A computing device capable of communicating over multiple types of communication channel pairing data for use with a further type of communication channel, the device being arranged to communicate pairing data with another device in response to a pairing stimulus and to communicate that pairing data over each of said multiple types of communication channel.

The invention relates to a computing device capable of communicating pairing data with another device so as to effect a pairing operation.

Computing devices include desktop and laptop computers, personal digital assistants (PDAs), mobile telephones, smartphones, digital cameras, digital music players, printers and headsets. They also include converged devices incorporating the functionality of one or more of the classes of device already mentioned, together with many other industrial and domestic electronic appliances.

In order for two computing devices to exchange data securely it is normally necessary for some initial communication to take place during which the two devices establish that they can permissibly work together. A common problem is to associate two devices in a way that is secure and that is also convenient for the user to set up. It may therefore be necessary for each device to perform some kind of authentication process before agreeing to work with the other device. The process of associating two devices is sometimes referred to as ‘pairing’. A secure solution should preferably ensure that a device does not get paired without the owner's knowledge and consent. One solution is to require the user to enter some form of pass code on both devices, but this can be inconvenient for the user and is not supported by some devices.

An alternative solution to user key entry is for some form of pairing key data to be exchanged over a communication channel. In order to increase security, this data may be exchanged over an Out Of Band (OOB) channel, e.g. using a technology that is different from the wireless bearer that is going to be used for the secure channel. When using OOB channels, the pairing keys can be generated by software in one or both of the computing devices. Keys generated by the devices themselves are typically more secure than PIN codes selected and/or entered by users. Also, exchanging pairing keys over an OOB channel is potentially more convenient for the user than manually entering a PIN code.

Once pairing key values have been exchanged the devices may use some cryptographic algorithm to verify the combination of keys before regarding the other device as being associated and authenticated.

The pairing key exchange may be symmetrical (for example, each device pushes its key to the other and then performs a similar algorithm) or asymmetrical (for example one device may send its key and then the other device responds).

There are many different types of OOB channel. For example, the Wireless USB Specification lists a user interface, memory card and wired Universal Serial Bus (USB) as examples of OOB channels. Near Field Communication (NFC) is a form of OOB communication that has been proposed by Bluetooth™ developers. The Bluetooth Specification v2.1 and Wireless USB v1.0 both include information on OOB association and authentication.

Some forms of pairing key exchange may require intervention by the user via a user interface (e.g. selecting to exchange pairing keys via NFC). For other forms of pairing key exchange a user input via a conventional user interface may not be required (e.g. if a wired USB interface that is always available exists between the two devices). However, irrespective of whether or not the user is required to select the communication channel to be used for exchanging the pairing key data, the underlying assumption with existing pairing mechanism is that a single means of pairing key exchange will be used at a time. For example, the user chooses whether to pair the two devices using NFC (e.g. by selecting this option via the user interface and then placing the devices together) or by a physical connection (e.g. by connecting the two devices with a USB cable).

It can be envisaged that in the future many devices will be capable of exchanging pairing data over multiple different types of communication channel. In order to maintain the current mechanism of transferring key pairing data via a single means of communication, it is anticipated that the users of both devices will be required to select which means of communication is to be used for conducting a particular key exchange. This will typically require additional user interaction (such as choosing from a list) which detracts from usability, particularly since many users already find device pairing a complicated process. In addition, some forms of key exchange could be passive, e.g. a key pairing exchange using WiFi. Therefore, there is a need for an improved computing device for communicating key pairing data with another device.

According to a first aspect of the invention, there is provided a computing device capable of communicating over multiple types of communication channel pairing data for use with a further type of communication channel, the device being arranged to communicate pairing data with another device in response to a pairing stimulus and to communicate that pairing data over each of said multiple types of communication channel.

The computing device may comprise means for translating the pairing data into signals for transmission over each of the multiple types of communication channel.

The device may be arranged not to communicate with the other device over said further type of communication channel without having received pairing data from said other device.

The device may be arranged to transmit pairing data to the other device in response to the pairing stimulus.

The device may be arranged to transmit the pairing data over each of said multiple types of communication channel responsive to receiving a request for pairing data over at least one of those multiple types of communication channel.

The device may be arranged to generate the pairing data in response to the pairing stimulus.

The device may be arranged to, responsive to receiving an indication that the pairing data has been successfully received by the other device, not transmit that data as pairing data in response to the next occurring pairing stimulus.

The device may be arranged to, responsive to receiving an indication that the pairing data has been successfully received by the other device, stop transmitting that pairing data over the multiple types of communication channel.

The device may be arranged to receive pairing data over each of said multiple types of communication channel.

The device may be arranged to accept as pairing data data received over any of the multiple different types of communication channel.

The device may be arranged to, when it has received pairing data over one of said multiple types of communication channel, ignore pairing data received over others of said multiple types of communication channel until a new pairing stimulus occurs.

The device may be arranged to request pairing data from another device over at least one of said multiple types of communication channel.

The device may be arranged to request pairing data over each of said multiple types of communication channel.

The device may be arranged to request pairing data over at least one, but not all, of the multiple types of communication channel and to accept as pairing data data received over any of the multiple types of communication channel responsive to that request.

The device may be arranged to, in response to receiving the pairing data, transmit an indication to the other device that the pairing data has been successfully received.

At least one of the multiple types of communication channel may be a wired connection with the device being capable of transmitting pairing data over the wired connection.

At least one of the multiple types of communication channel may be a wireless connection with the device being capable of transmitting pairing data over the wireless connection.

At least one of the multiple types of communication channel may be an out-of-band channel.

At least one of the multiple types of communication channel may be an infrared channel.

The device may be arranged to communicate pairing data for use with a Bluetooth channel over the infrared channel.

The device may comprise a user interface, the device being arranged to determine that a pairing stimulus has occurred responsive to receiving a user input via the user interface.

The device may be arranged to determine that a pairing stimulus has occurred responsive to a type of communication channel being enabled.

The device may comprise a connector for forming a physical connection with the other device, the device being arranged to determine that a pairing stimulus has occurred responsive to a physical connection being formed with the other device via said connector.

According to a second aspect of the invention, there is provided a computer program for configuring a computing device capable of communicating over multiple types of communication channel pairing data for use with a further type of communication channel such that the device is arranged to communicate pairing data with another device in response to a pairing stimulus and to communicate that pairing data over each of said multiple types of communication channel.

According to a third aspect of the invention, there is provided a method for a computing device capable of communicating over multiple types of communication channel pairing data for use with a further type of communication channel, the method comprising the device communicating pairing data with another device in response to a pairing stimulus, said pairing data being communicated over each of said multiple types of communication channel.

For a better understanding of the present invention, reference is made by way of example to the following drawings, in which:

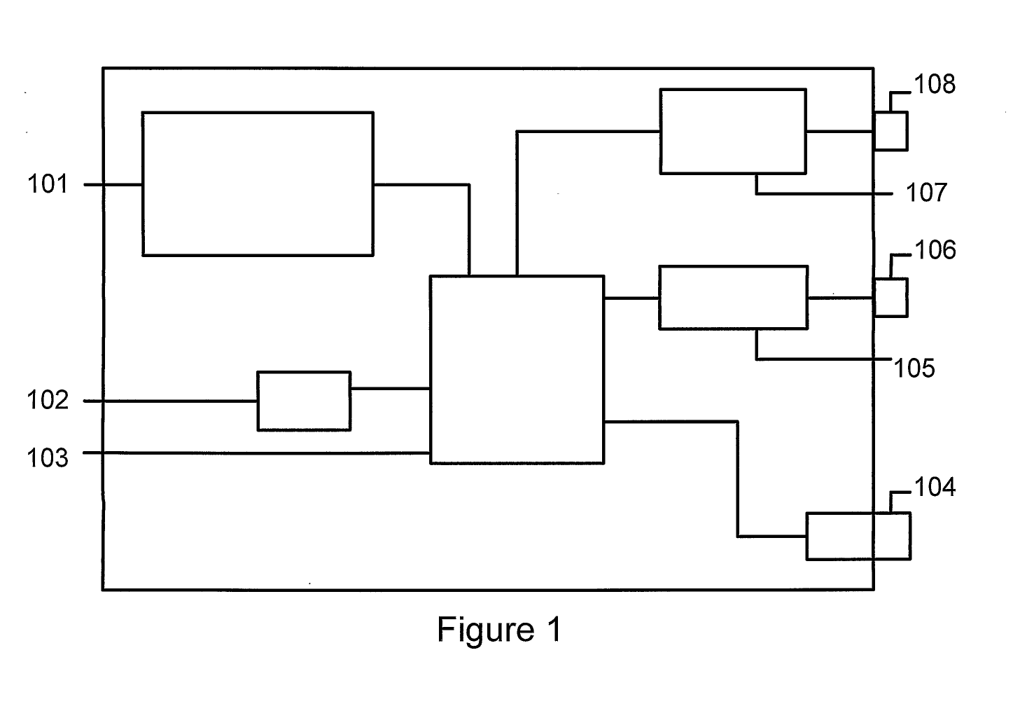

FIG. 1 shows a computing device for communicating key pairing data with another device;

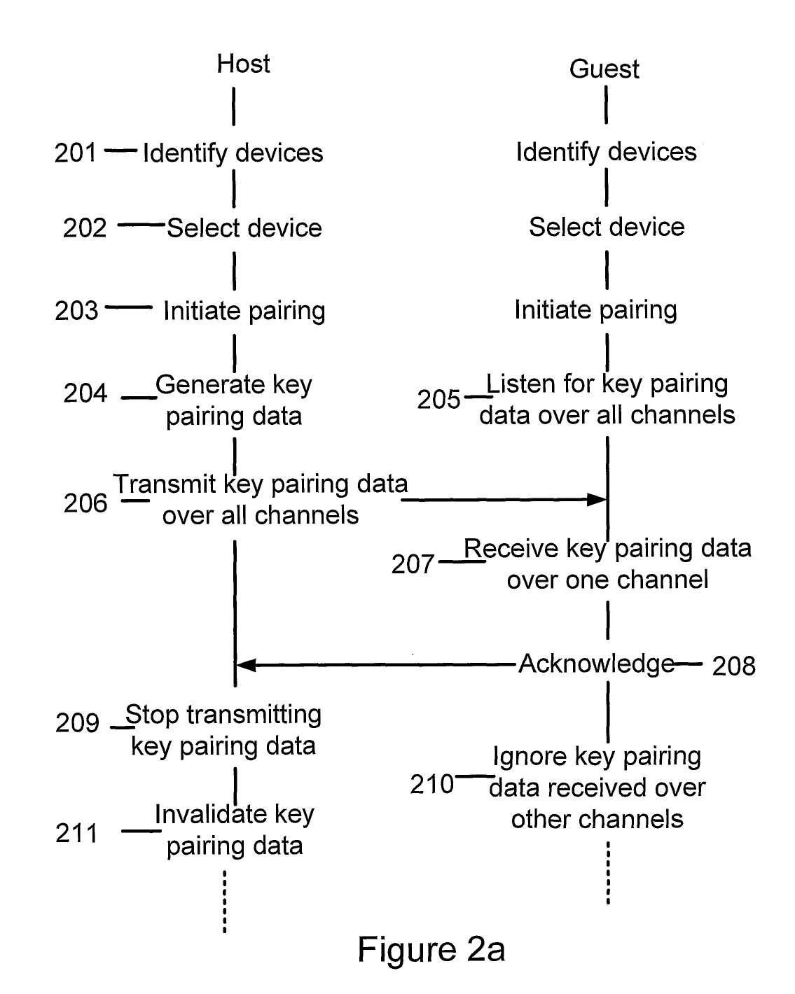

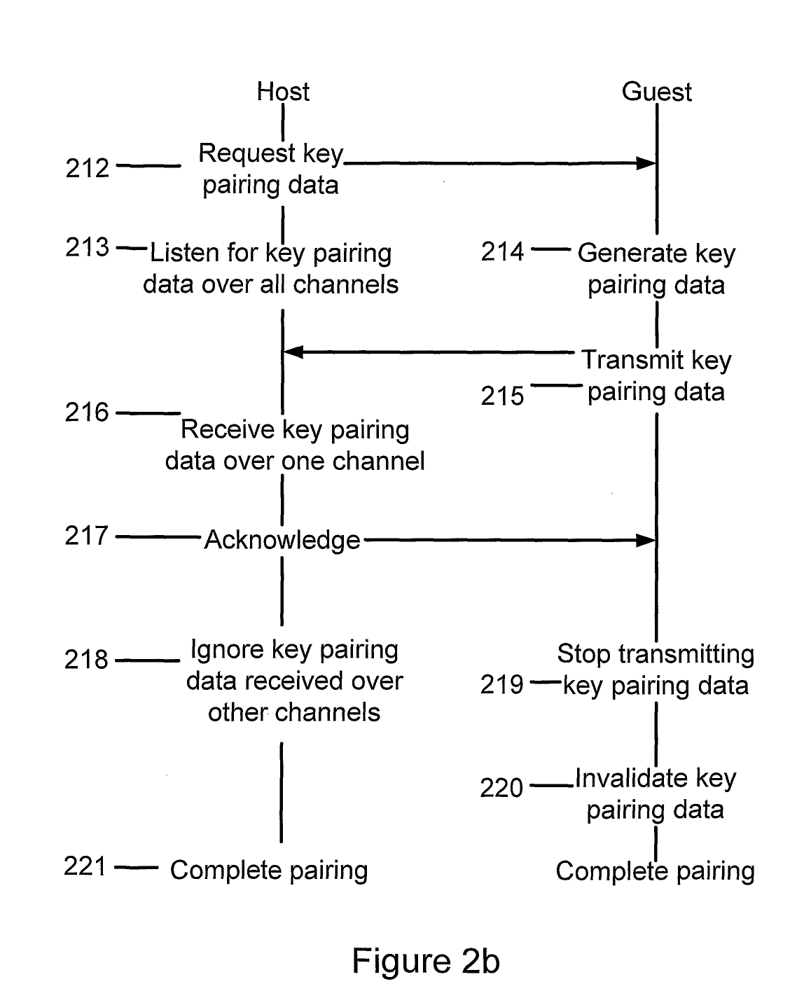

FIGS. 2a and 2b show a host device and a guest device exchanging information during a pairing procedure; and

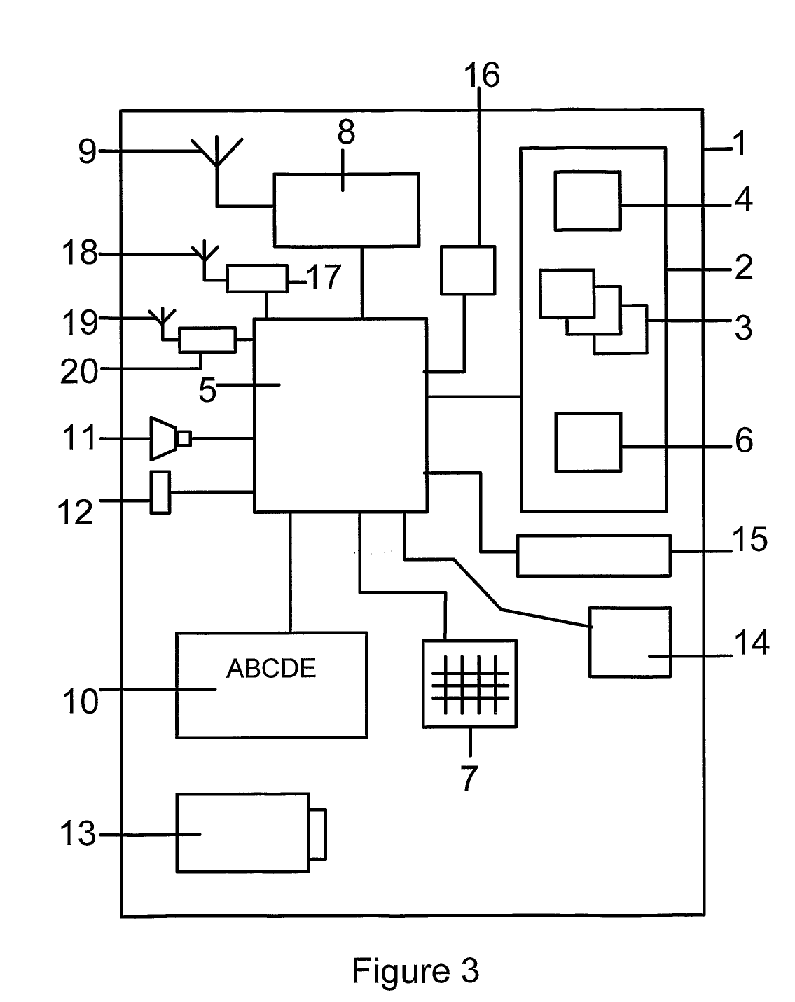

FIG. 3 shows a mobile phone capable of performing a pairing procedure.

A computing device may address the problems described above by making pairing key data available to all channels whenever a pairing stimulus occurs (when acting as the “transmitting” device) and by accepting received pairing key values from any available channel (when acting as the “receiving” device). A device's role as a “transmitting” or “receiving” device may change during the pairing procedure as the devices transmit their respective pairing data. A device may take on both roles at the same time.

A computing device may be capable of communicating over multiple types of communication channel pairing data for use with a further type of communication channel. The device may be arranged to communicate pairing data with another device in response to a pairing stimulus. Suitably this communication is achieved by the device communicating the pairing data over each of the multiple types of communication channel it is arranged to use for that purpose.

The communication channels over which the device communicates pairing data may be OOB channels. These are communication channels that use a different transmission medium and/or transmission protocol from the actual wireless bearer (the channel for which the pairing data is being exchanged). OOB channels are therefore communication channels that are of a different type from the communication channel for which the pairing data is being exchanged. However, although the device may suitably communicate the pairing data over OOB channels, the principles of the pairing exchange mechanism described herein may be implemented using any type of communication channel. As an example, if the device is capable of communicating via Bluetooth, infrared and WiFi, it may communicate the pairing data needed to establish a Bluetooth connection over an infrared channel and over a WiFi channel.

Pairing data may be the data that two or more devices exchange to establish that they can work together. Typically this data relates to a specific communication channel over which the future collaboration between the devices will take place. A device may be arranged not to communicate over a communication channel if it does not receive pairing data for use with that channel. The device may also not communicate over a communication channel if the pairing data it receives from the other device is not successfully authenticated.

The device may not always be capable of communicating data over all of the types of channel theoretically available to it. For example, some channels may have to be enabled (e.g. by forming a physical connection between two devices) before the device is capable of communicating over those channels, or some channels may not be used because they are less convenient than other channels that are available. The device may communicate pairing data over the channels it is capable of communicating over at the time.

The computing device described above is advantageous because by communicating pairing data over each of the available channels it removes the need for the user to have to select which channel to use via a user interface. It also means that the user does not need to know which types of channel the respective devices are configured to support. Providing that both devices are configured to transmit pairing data over at least one common type of channel, the successful exchange of pairing data over that common channel should be achieved automatically by the devices, without the user having to identify the common channel or instruct the devices to exchange their pairing data over the common channel. The user may still enable a particular channel to be used by one or both of the device's (e.g. by plugging in a cable or by placing the devices close together to enable NFC communication). However, the user is not required to select which channel should be used. In particular, the user is not required to select s channel at the time when the pairing data is sent. This makes a device that supports multiple channels for transferring pairing data as usable as one that only supports a single channel for transferring pairing data. This is a significant advantage when one considers that pairing has historically been perceived as a relatively user-unfriendly procedure.

An example of the functional components that may be contained within a computing device are shown in FIG. 1. The device comprises a user interface 101, a key generator 102 and a pairing control unit 103. The device also comprises several means for communicating pairing data with another device, including an infrared unit 107 and its associated antenna 108, a Bluetooth unit 105 and its associated antenna 106 and a USB unit 104. Each of the means for communicating pairing data is suitably capable of translating pairing data into signals suitable for transmission over the appropriate channel.

The pairing control unit is arranged to control the pairing procedure. The pairing control unit may be arranged to initiate the pairing procedure responsive to the occurrence of a pairing stimulus. The pairing stimulus is typically required to cause pairing key values to be made available. The pairing stimulus could be generated by a user interface event (such as the user choosing to initiate pairing) or by the enablement of a channel (such as plugging in a USB cable on a device that supports the use of wired USB for key exchange). The user may be passive with respect to the pairing stimulus. The pairing stimulus may also be generated externally of the device. For example, the device may determine that a pairing stimulus has occurred responsive to receiving a pairing request from another device. The device may also determine that a pairing stimulus has occurred responsive to a user input that is not associated with pairing. For example, the device may determine that a pairing stimulus has occurred responsive to the user requesting a particular type of communication channel, e.g. a WiFi channel.

The pairing control unit may cause the key generator to generate key pairing data responsive to the pairing stimulus. Alternatively, the key pairing data may be stored in a memory of the device or may be entered by the user via the user interface. The pairing control unit may also cause pairing keys to be generated on device start-up and then renewed when necessary.

Whatever the source of the stimulus, the device is arranged to make the same pairing key data available to all OOB channels, i.e. all channels that use a different technology from the actual wireless bearer. This can be achieved either by pushing the pairing key data to the channel or by providing a means of allowing the OOB channel to request the pairing key data. For example, the other device may request to receive pairing data responsive to a pairing stimulus. It is important that the same pairing key data is supplied to each of the communication units for transmission across each type of communication channel. Each of the communication units may be arranged to repeatedly transmit the pairing data, until instructed not to by the pairing control unit.

If the device typically generates multiple sets of pairing key values (e.g. for pairing operations with different devices or in response to different pairing stimuli), the pairing control unit may be arranged to invalidate a particular set of pairing key values after they have been used. The key pairing values may be invalidated by marking them as invalid in memory or by informing each of the communication units that the key values they have been transmitting are now invalid and should be deleted or marked as invalid in their local memory. The device may be arranged not to use invalid pairing key data in response to the next pairing stimulus.

When the receiving device receives the pairing key values it indicates to the transmitting device that the pairing key values have been successfully received. In response to receiving this indication, the computing device stops transmitting those pairing key values. This may be achieved by the pairing control unit informing all communication units that pairing is complete. This “completion” of pairing may be a message received from the other device indicating only that the pairing values have been received. Alternatively, pairing may be deemed to be completed only on receipt of a message indicating both that the pairing values have been received and that any necessary authentication processes have been completed on those values (either successfully or unsuccessfully). This information is suitably communicated to the communication units in order that they can cease transmitting the pairing key values and discard the pairing key values that they were transmitting.

When the computing device is receiving the pairing key values rather than transmitting them (and the device may perform this receiving procedure at the same time as the transmitting procedure), the pairing control unit may instruct one or more of the communication units to request the pairing data from the other device.

When pairing key values are received via any OOB channel the pairing operation is completed and any subsequent pairing key values received are ignored.

FIGS. 2a and 2b illustrate an example of a pairing data exchange between two devices. The exchange takes place between a “host” device that takes the lead in the exchange and a “guest” device with which the host is attempting to pair. The procedure starts in FIG. 2a with both devices identifying devices in the vicinity with which a pairing operation is possible (step 201). For example, the devices may both search for Bluetooth devices in the vicinity in order to perform a Bluetooth pairing procedure. In step 202, each device selects which of the available devices the pairing operation is to be performed with. The other device may be selected responsive to the user selecting the appropriate device from a list of available devices shown in the display.

Steps 201 and 202 may not be performed by the pairing devices, particularly in the case of straightforward pairing operations in which few devices are in the vicinity of the host device and/or one or more of the devices is a relatively simple device such as e.g. a remote control.

In step 203 both devices initiate a pairing operation. In the host device, this results in the generation of key pairing data (step 204), while the guest device commences listening for key pairing data over all the OOB channels available to it (step 205). The host device transmits the key pairing data over all of the OOB channels it is capable of communicating over in step 206. The guest device receives the key pairing data over at least one of its OOB channels (step 207) and sends an acknowledgement to the host device accordingly (step 208). In response to this acknowledgement, the host devices stops transmitting its key pairing data (step 209) and the guest device ignores key pairing data received over all its OOB channels until the next pairing stimulus (step 210). The host device then invalidates the key pairing data it had been transmitting to the guest device (step 211).

The exchange of data in the opposite direction is shown in FIG. 2b. In step 212 the host device requests key pairing data from the guest device. The guest device generates key pairing data responsive to this request (step 214) and transmits this data over all its OOB channels (step 215). Meanwhile, the host device listens for key pairing data over all its OOB channels (step 213).

The host device may request the guest's devices key pairing data over any one or more of the communication channels available to it. The device may suitably be arranged to transmit the request over all of the OOB channels it is capable of using, as this maintains one of the advantages of a device arranged to transmit key pairing data over all its OOB channels, namely that the device does not need to know which channels are supported by the other device in order to complete the pairing operation. Similarly, a device may be arranged to communicate the acknowledgement message for received key pairing data over all of the OOB channels available to it.

Rather than generating key pairing data responsive to the host device's request, as shown in FIG. 2b, the guest device may generate its key pairing data as soon as it initiates its key pairing operation.

The procedure of FIG. 2b now proceeds in a similar manner to that shown in FIG. 2a, with the host device receiving key pairing data over one of its OOB channels (step 217), acknowledging receipt of the key pairing data to the guest device (step 217) and ignoring key pairing data received over its OOB channels until the next pairing stimulus (step 218). The guest device stops transmitting its key pairing data responsive to receiving the acknowledgement from the host device (step 219) and invalidates its key pairing data (step 220). Both devices then complete the pairing operation (step 221).

Although not shown in FIGS. 2a and 2b, one or both devices may perform some cryptographic algorithm or other authentication process before accepting the pairing with the other device.

A computing device may be configured to implement a pairing data exchange mechanism as described herein by means of a computer program, and suitably by an operating system of the computing device. The program may be in the form of source code, object code, a code intermediate source and object code such as code in partially compiled form, or in any other form suitable for use in the implementation of processes according to the invention. The computer program may be on or in a carrier. The carrier may be any entity or device capable of carrying the program.

Computing devices include desktop and laptop computers, personal digital assistants (PDAs), mobile telephones, smartphones, digital cameras, digital music players, printers and headsets. They also include converged devices incorporating the functionality of one or more of the classes of device already mentioned, together with many other industrial and domestic electronic appliances.

The way of communicating key pairing data described herein is particularly applicable to mobile phones and to the devices that pair with mobile phones including PCs and feature-rich peripherals. However, the pairing data communication method is not dependent on any specific technology or method of key exchange.

FIG. 3 shows a mobile phone that may be arranged to exchange pairing data with another device over multiple types of communication channel. The mobile phone, shown generally at 1, includes a non-volatile memory 2 that stores instructions defining application programs (shown schematically at 3) and an operating system (shown schematically at 4). The mobile phone may be configured in such a way that the operating system controls the memory. The mobile phone has a CPU 5 which can execute the instructions stored in memory 2. The non-volatile memory also stores data (shown schematically at 6) defining a series of resource usage profiles. The mobile phone has a keypad 7 by which a user can control the operation of the phone. The mobile phone has an RF transceiver 8 coupled to an antenna 9, by means of which it can transmit and receive data according to a mobile phone radio protocol. The mobile phone includes a Bluetooth transceiver 17 coupled to an antenna 18 and an infrared transceiver 20 coupled to an antenna 19. The mobile phone may also be able to receive data that it uses to determine its location via the receiver, e.g. GPS data. The transceiver is coupled to the CPU. Data received by the transceiver is passed to the CPU and data can be passed from the CPU to the transceiver for transmission. The mobile phone has a display 10 for displaying data to a user (e.g. map data), a loudspeaker 11 for producing sound (e.g. to reproduce audio data received through the transceiver 8) and a microphone 12 for receiving sound (e.g. to capture audio data that is subsequently to be transmitted by the transceiver 7). The mobile phone is powered by a battery 13. The mobile phone may be provided with a working memory, which may be on the CPU or in RAM (random access memory) 15 coupled to the CPU. The mobile phone may also be provided with a ROM (read only memory) 16 coupled to the CPU.

The mobile phone may suitably be configured by its operating system to communicate pairing data over multiple types of communication channel as described herein. The pairing control unit shown in FIG. 1 may then be implemented by the CPU acting under software control.

The devices and methods for communicating pairing data that are described herein may enable OOB key exchange to become more usable as devices support multiple OOB channels.

OOB channels include both physical and wireless connections. Wireless OOB channels may include WLAN, Bluetooth, NFC, WiFi, wireless USB, infrared and radio frequency ID (RFID). Physical channels may include wires and memory devices such as USB flash storage drives.

Infrared is particularly suitable for use as an OOB channel. Infrared is almost as secure as a wired transport. Because of the short range and directionality of infrared, it is more secure than undirected wireless technologies. Although it is possible to pick up an unexpected infrared signal due to reflection, it is generally impractical to carry out a ‘Man In The Middle’ attack using infrared. At the same time, infrared does not require the user to carry a separate cable and so it is more convenient than wired USB. Infrared is also a mature technology that most mobile devices are capable of using, which means that it is generally less costly to introduce into a device than newer technologies such as NFC. Also, because infrared hardware is already present in many devices, it may be possible to configure a device to perform an OOB pairing key exchange over infrared by storing appropriate software on the device. This might even be possible as an after-market addition.

A computing device may suitably be arranged to communicate key pairing data over an infrared channel. The key pairing data may be for use with a Bluetooth channel.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1-28. (canceled)

29. A computing device comprising:
multiple types of communication channel, the device being capable of communicating over the multiple types of communication channel pairing data for use with a further type of communication channel, the device being arranged to communicate pairing data with another device in response to a pairing stimulus and to communicate that pairing data over each of said multiple types of communication channel.

30. A computing device as claimed in claim 29, wherein the computing device comprises means for translating the pairing data into signals for transmission over each of the multiple types of communication channel.

31. A computing device as claimed in claim 29, wherein the device is further arranged not to communicate with the other device over said further type of communication channel without having received pairing data from said other device.

32. A computing device as claimed in claim 29, wherein the device is arranged to transmit pairing data to the other device in response to the pairing stimulus.

33. A computing device as claimed in claim 32, wherein the device is arranged to transmit the pairing data over each of said multiple types of communication channel responsive to receiving a request for pairing data over at least one of those multiple types of communication channel.

34. A computing device as claimed in claim 32, wherein the device is further arranged to, responsive to receiving an indication that the pairing data has been successfully received by the other device, stop transmitting that pairing data over the multiple types of communication channel.

35. A computing device as claimed in claim 29, wherein the device is arranged to receive pairing data over each of said multiple types of communication channel.

36. A communication device as claimed in claim 35, wherein the device is further arranged to accept as pairing data data received over any of the multiple different types of communication channel.

37. A communication device as claimed in claim 36, wherein the device is further arranged to, when it has received pairing data over one of said multiple types of communication channel, ignore pairing data received over others of said multiple types of communication channel until a new pairing stimulus occurs.

38. A communication device as claimed in claim 35, wherein the device is further arranged to request pairing data from another device over at least one of said multiple types of communication channel.

39. A communication device as claimed in claim 38, wherein the device is arranged to request pairing data over each of said multiple types of communication channel.

40. A communication device as claimed in claim 35, wherein the device is further arranged to request pairing data over at least one, but not all, of the multiple types of communication channel and to accept as pairing data data received over any of the multiple types of communication channel responsive to that request.

41. A computing device as claimed in claim 29, wherein at least one of the multiple types of communication channel is a wired connection with the device being capable of transmitting pairing data over the wired connection.

42. A computing device as claimed in claim 29, wherein at least one of the multiple types of communication channel is a wireless connection with the device being capable of transmitting pairing data over the wireless connection.

43. A computing device as claimed in claim 29, wherein at least one of the multiple types of communication channel is an out-of-band channel.

44. A computing device as claimed in claim 29, wherein the device comprises a user interface, wherein a determination that a pairing stimulus has occurred is done responsive to receiving a user input via the user interface.

45. A computing device as claimed in claim 29, wherein the device is arranged to determine that a pairing stimulus has occurred responsive to a type of communication channel being enabled.

46. A communication device as claimed in claim 45, wherein the device further comprises a connector for forming a physical connection with the other device, the device being arranged to determine that a pairing stimulus has occurred responsive to a physical connection being formed with the other device via said connector.

47. A computer program for configuring a computing device capable of communicating over multiple types of communication channel pairing data for use with a further type of communication channel such that the device is arranged to communicate pairing data with another device in response to a pairing stimulus and to communicate that pairing data over each of said multiple types of communication channel.

48. A method for a computing device capable of communicating over multiple types of communication channel pairing data for use with a further type of communication channel, the method comprising receiving a pairing stimulus, and communicating pairing data with another device in response to the pairing stimulus, said pairing data being communicated over each of said multiple types of communication channel.
